(19) United States
(12) Patent Application Publication
(10) Pub. No.: US 2007/0152844 A1
(43) Pub. Date: Jul. 5, 2007

(54) Traffic condition monitoring devices and methods

(76) Inventors: Joel S. Hartley, Solana Beach, CA (US); Mark A. Wells, La Jolla, CA (US)

Correspondence Address: BUCHANAN INGERSOLL & ROONEY PC, P.O. BOX 1404, ALEXANDRIA, VA, 22313-1404, US

(21) Appl. No.: 11/649,070

(22) Filed: Jan. 3, 2007

Related U.S. Application Data
(60) Provisional application No. 60/755,050, filed on Jan. 3, 2006.
(60) Provisional application No. 60/755,051, filed on Jan. 3, 2006.
(60) Provisional application No. 60/755,052, filed on Jan. 3, 2006.

(51) Int. Cl. G08G 1/09; G08G 1/01; G08G 1/123

(52) U.S. Cl. 340/905; 340/936; 340/995.13

(57) ABSTRACT

An apparatus for monitoring traffic conditions comprising at least one mobile device is disclosed. The mobile device has at least one receiver that is configured to receive speed input and location input, memory, that is operatively connected to the timer and the at least one receiver that is configured to store the speed input received by the at least one receiver and a processor. The processor is operatively connected to the memory and the at least one receiver. The mobile device also has at least one transmitter that is operatively connected to the processor and is configured to send messages or alerts.

### CROSS REFERENCE TO RELATED APPLICATIONS

This is a utility patent application based upon U.S. Provisional Patent Application Ser. Nos. 60/755,050, 60/755,051 and 60/755,052, which were all filed on Jan. 3, 2006, and which are all incorporated by reference in their entirety.

### FIELD OF INVENTION

The present invention relates to tracking apparatuses.

### BACKGROUND OF THE INVENTION

Traffic monitoring systems have been developed to warn subscribers to such systems of problematic traffic conditions, such as traffic jams or accidents.

The devices and systems currently being used to monitor traffic conditions do not permit a subscriber to learn whether a subscriber's vehicle is violating speed limit laws if the subscriber is not in the vehicle. Such information is useful to a parent seeking to ensure a child borrowing a vehicle is traveling at safe speeds, or a distribution company seeking to ensure its employees drive safely.

Further, devices and systems currently being used often require third parties outside the network to monitor traffic conditions. Consequently, the traffic condition information obtained from such systems is delayed and not necessarily real time information. It would be preferred to avoid the need of using third party traffic monitoring to avoid the costs associated with such services while also being able to obtain real time traffic information. Preferably, the system of monitoring traffic conditions would involve devices already kept by each subscriber or sold to each subscriber so that the equipment needed to perform such traffic monitoring can be minimized. Such mobile devices would ideally have minimum memory requirements to ensure the size of the device can be small and be installed within a vehicle without requiring significant amounts of power or space.

### SUMMARY OF THE INVENTION

According to an embodiment of the present invention, we provide an apparatus for monitoring traffic conditions that includes at least one mobile device. The at least one mobile device has at least one receiver that is configured to obtain at least one of speed input and location input, wherein the location input has at least one of a speed input or input the at least one receiver uses to generate a speed input for the mobile device. The mobile device also has memory that is operatively connected to the at least one receiver and is configured to store at least one of the speed input and the location input obtained by the at least one receiver. The mobile device also has a processor that has a traffic speed level variable that defines a traffic speed level and a traffic jam time period variable that defines a traffic jam time period. The processor is operatively connected to the memory and the at least one receiver and is configured to compare the speed input stored in the memory with the speed input that was obtained by the at least one receiver to determine when the speed input being obtained by the at least one receiver has been at or below a traffic speed level for at least a traffic jam time period. The processor is configured to generate a traffic alert when it determines the speed input being obtained by the at least one receiver has been at or below a traffic speed level for at least a traffic jam time period, the traffic alert including position data. The position data has the location input obtained by the at least one receiver at the time the traffic alert is generated. The mobile device also has at least one transmitter that is operatively connected to the processor and is configured to send the traffic alert when the processor determines that the obtained speed input has been at or below a traffic speed level for at least a traffic jam time period.

The apparatus can also have a network device that has at least one receiver configured to receive the traffic alert sent from the at least one mobile device. The network device can also have at least one transmitter that is operatively connected to the at least one receiver of the network device and is configured to send traffic alerts to the at least one mobile device.

It should be noted that the location input can include at least one of a time, a bearing, a speed and a geographical position. Of course, the time may include the date and a time stamp or may be a time provided by a counter or timer.

In another embodiment the mobile device can have at least one receiver that is configured to obtain location input, speed input and encoded speed limit input. The location input defines a location at which the mobile device is positioned. The encoded speed limit input is encoded such that it has at least one speed fence having a maximum speed limit value. The mobile device also has a processor that is operatively connected to the at least one receiver, the processor is configured to decode the encoded speed limit input and compare the speed input with the speed limit input and generate a speed limit alert when it determines that the speed input is greater than or equal to the maximum speed limit value for the location at which the mobile device is positioned. The mobile device also has at least one transmitter that is operatively connected to the processor and the at least one receiver and is configured to transmit the location input obtained by the at least one receiver and send a speed limit alert when the processor determines that the speed input is greater than or equal to the maximum speed limit value.

It should be noted that the speed limit alert may be a short message, which is a message formatted for sending within a short message service, or SMS.

In yet another embodiment, the mobile device may also have memory operatively connected to the at least one receiver that is configured to store route data. The route data has at least one of the speed input and the location input. For such embodiments, the processor of the mobile device can be configured to store the route data in the memory as an encoded short message. Similarly, the at least one transmitter can transmit the route data.

In another embodiment, we provide a mobile device that has at least one receiver configured to obtain speed input and location input, memory and a processor. The processor is operatively connected to the at least one receiver and the memory and is configured to store route data in the memory. The route data has starting point data and incremental point data, wherein the processor is configured to store a first location input as starting point data in the memory and thereafter evaluate the location input and speed input obtained by the at least one receiver and store a second location input as incremental route data in the memory when one of the speed input and location input substantially changes from the starting point data.

It should be understood that the location input can substantially change when the difference between the first location input and a second location input is at least one of at least a 0.6 minute change in at least one of latitude and longitude, at least a 10 minute change in time, at least a 25 mile per hour change in speed and at least a 22.5 degree change in bearing. Of course, other changes in location input can also be considered a substantial change from the first location input.

The mobile device may also have at least one transmitter that is configured to send the route data stored in the memory. The route data may be stored as a short message. Such a short message may have a header, a starting position, and at least one incremental position, wherein the starting position includes the starting point data and the at lest one incremental position includes the incremental route data.

Such a mobile device can also be incorporated into a system having a network device that has at least one receiver configured to receive the route data sent by the at least one transmitter and has memory configured to store the route data received by the at least one receiver of the network device for each mobile device.

The network device can also have a processor that is operatively connected to the memory of the network device and the at least one receiver of the network device and is configured to decode the route data sent by the transmitter of the at least one mobile device and store the decoded route data in the memory of the network device for each mobile device. The processor can additionally be configured to display the route data of at least one of the mobile devices that is stored in the memory of the network device.

The processor of the network device can also be configured to access the route data stored in the memory of the network device and compare the route data received by the at least one receiver of the network device with historical route data previously received by the at least one receiver of the network device and stored in the memory of the network device to determine if a traffic condition exists and generate a traffic alert when the processor of the network device determines that a traffic condition exists.

In yet another embodiment a system for monitoring the location of at least one object is provided that includes at least one mobile device and a network device. The at least one mobile device has at least one receiver that is configured to obtain location input, speed input and encoded speed limit input. The location input defining a location at which the at least one mobile device is positioned and the encoded speed limit input being encoded to have at least one speed fence having a maximum speed limit value. The at least one mobile device also has a processor that is operatively connected to the at least one receiver and is configured to decode the encoded speed limit input and compare the speed input with the speed limit input and generate a speed limit alert when it determines that the speed input is greater than or equal to the maximum speed limit value for the location. The mobile device also has at least one transmitter that is operatively connected to the processor and the at least one receiver and is configured to transmit the location input obtained by the at least one receiver and send a speed limit alert when the processor determines that the speed input is greater than or equal to the maximum speed limit value for the location.

The network device has at least one receiver configured to receive location input transmitted by the at least one transmitter of the at least one mobile device, memory having speed limit mapping data, at least one transmitter configured to send encoded speed limit input to the at least one mobile device and a processor configured to compare location input received from the at least one mobile device with the speed limit mapping data and encode the speed limit mapping data for the location input received from the at least one mobile device into encoded speed limit input so that the at least one transmitter can send the encoded speed limit input to the at least one mobile device that corresponds to the location input received from that mobile device. The speed limit input is encoded by the processor of the network device such that it has at least one speed fence having a maximum speed limit value.

It should be noted that the speed limit input can be encoded with speed fences by the processor of the network device by accessing map that has speed limit data, defining the boundaries of the map data that correspond with the speed limits, modeling each boundary of the map data into geometric structures such as polygons and lines, and overlaying speed fences with lines for high speed traffic corridors. The speed fences can then be encoded into a short message that is transmitted to the mobile device.

The at least one mobile device of such an embodiment can also have memory operatively connected to the processor that is configured to store route data in the memory. The route data can include at least one of location input and speed input. Of course, the transmitter of the at least one mobile device can send such route data to the receiver of the network device. The processor of the network device can also be configured to access the route data stored by the memory of the network device to find the route data for at least one of the at least one mobile device such that the memory of the network device can store the route data for each mobile device.

The processor of the network device can also be configured to access the route data stored by the memory of the network device and determine when a traffic condition exists based on the stored route data and recently received route data. When the processor of the network device determines that a traffic condition exists, such as a traffic jam or stop-and-go traffic conditions, it generates a traffic alert that is sent by the at least one transmitter of the network device.

Other details, objects, and advantages of the invention will become apparent as the following description of certain present preferred methods of practicing the invention proceeds.

### BRIEF DESCRIPTION OF THE DRAWINGS

In the accompanying drawings we have shown present preferred embodiments of the invention and have illustrated certain present preferred methods of practicing the same.

FIG. 1 is a block diagram view of a first present preferred embodiment.

FIG. 2 is a block diagram view of a second present preferred embodiment.

FIG. 3 is a block diagram view of a third present preferred embodiment.

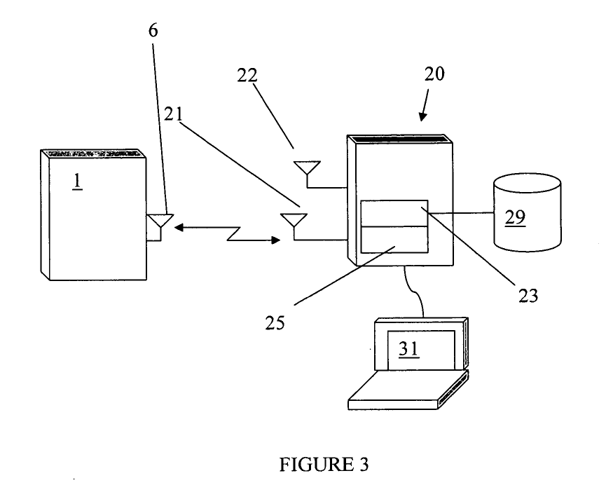

FIG. 4 is a flow chart showing the steps a first present preferred processor of a mobile device takes to determine whether a traffic condition exists.

FIG. 5 is a flow chart illustrating the steps a second present preferred processor of a mobile device takes to store route data in memory and send route data to a network device.

FIG. 6 is a flow chart of the steps a first present preferred network device takes to transmit encoded speed limit inputs having a speed fence.

FIG. 7 is a flow chart of the steps a third present preferred processor of a mobile device takes to determine whether it should generate a speed limit alert.

FIG. 8 is a block diagram illustrating a present preferred set of speed fences that may be generated from mapping data by a first present preferred processor of a network device.

FIG. 9 is a flow chart of the steps a second present preferred network device takes to evaluate whether a traffic condition exists.

### DETAILED DESCRIPTION OF PRESENT PREFERRED EMBODIMENTS

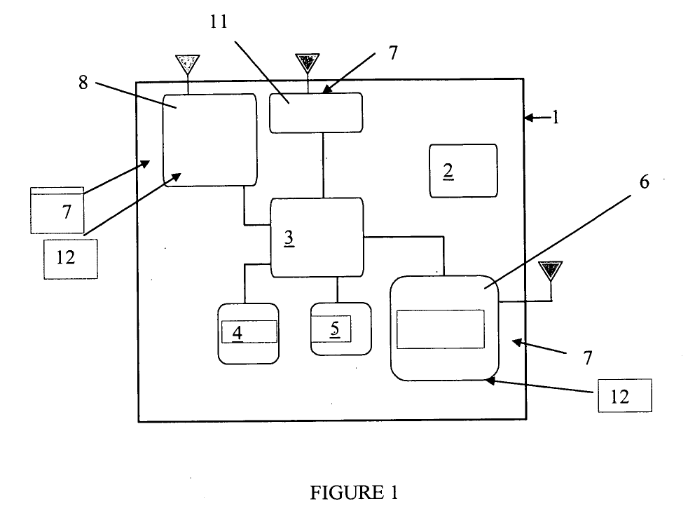

Referring to FIG. 1, the mobile device 1 has a processor 3 that is operatively connected to at least one receiver 7, which includes a global positioning system, or GPS, receiver 11, a local area network transceiver 8, and a cellular transceiver 6. The processor 3 is also operatively connected to a timer 4 and memory 5. A power supply 2 is connected to the mobile device 1 and provides power to the processor 3, at least one receiver 7, memory 5, and timer 4. It should be understood that the local area network transceiver 8 and cellular transceiver 6 include a transmitter 12 and a receiver 7 in each transceiver.

The GPS receiver 11 is configured to receive location input from a GPS satellite. The location input can include geographical positioning coordinates for the mobile device, the bearing of the mobile device, the speed of the mobile device and a time stamp at which the location input was sent by the GPS satellite. A GPS receiver can be used that obtains speed input by calculating the speed of the mobile device based on the location input received from a GPS system. In alternative embodiments, another receiver may be used in conjunction with the GPS receiver that is configured to receive speed input from the vehicle the mobile device is connected to. The mobile device may be installed in and/or on a vehicle such as a car, truck, boat, or airplane or other objects such as containers, trailers, packages, animals or other assets.

The memory 5 is operatively connected to the timer 4 and the at least one receiver 7 such that the memory is configured to store the speed input obtained by the at least one receiver 7 and the time at which the at least one receiver obtained that speed input. It should be understood by those skilled in the art that the processor may be configured to receive such input from the at least one receiver 7 and store such input in the memory. In an alternative embodiment, the time may be obtained from a time stamp provided in the location input received from the GPS system 9 that is received by the GPS receiver 11.

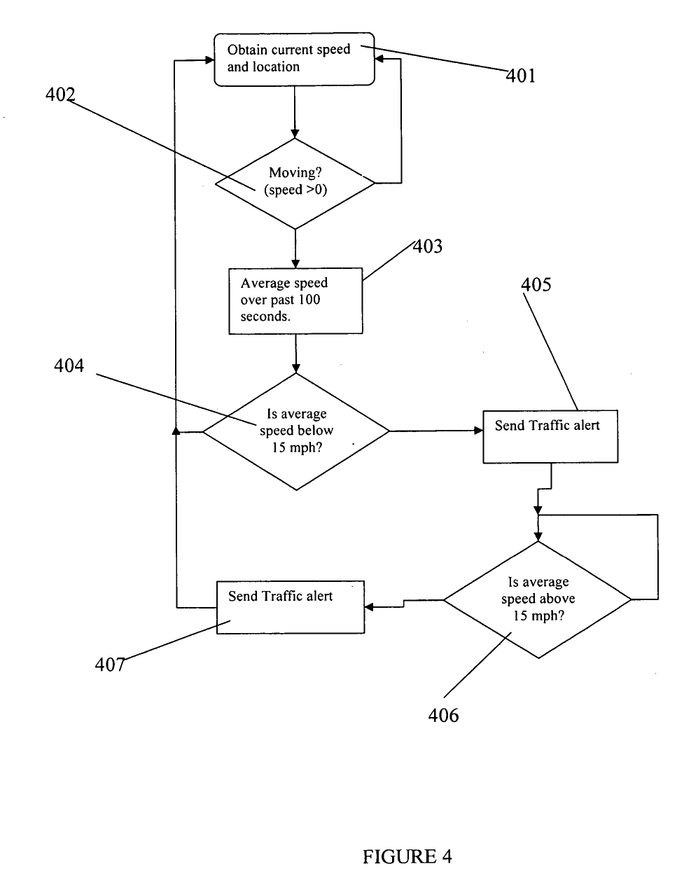

The processor 3 is configured to determine when a traffic jam, or traffic congestion, is taking place. For example, the processor may be configured to act in accordance with the protocol illustrated in FIG. 4. The processor first receives the speed input and the location input from the receivers 7, as illustrated in step 401. If the speed input corresponds with a rate of speed of zero miles per hour, the mobile device is not moving and the processor simply continues to monitor the speed of the vehicle to which the mobile device is attached as shown in step 402. If the speed input corresponds with a value greater than zero, the mobile device compares the speed input stored in the memory 5 with the time at which the speed input was received to determine when the speed input being received or calculated as speed input by the at least one receiver 7 has been at or below the traffic speed level for at least a traffic jam time period.

The processor may make such a comparison by averaging the speed inputs it has received over a traffic jam time period, such as one hundred seconds, as indicated in block 403. If the average speed is above a traffic speed level variable, the processor will determine that there is not a traffic jam as illustrated by block 404. In an alternative embodiment, the processor may compare the speed input with the speed input received over the past traffic jam time period and if the speed input is never below a traffic speed level variable, the processor will determine that a traffic jam condition does not exist. Of course, it should be understood by those skilled in the art that the processor can be configured in other ways to make comparisons of the stored speed input and the speed input being received or calculated by the at least one receiver 7 in order to detect a traffic jam condition using the traffic speed level variable and the traffic jam time period.

If the average speed is above the traffic speed variable, the processor determines that there is a traffic jam and generates a traffic jam alert. The traffic alert is then sent by at least one transmitter as indicated by block 405. When the average speed is above the traffic speed variable, the processor will determine that the traffic jam condition is over and send a second traffic alert identifying the cessation of the traffic jam condition as indicated by blocks 406 and 407.

The traffic alert has position data that includes the location input received by the at least one receiver at the time the traffic alert is generated. For example, if the location input indicated the mobile device was at 101 Main St. in San Francisco, Calif. at the time the processor of the mobile device determined that a traffic jam existed, the traffic alert would contain position data having location input identifying the location of the traffic jam as 101 Main St. in San Francisco, Calif. The traffic alerts are sent by at least one transmitter 12. It should be understood that the position data having location input obtained at the time the traffic alert is generated may include location input received within an insubstantial amount of time before the processor determined a traffic condition existed such that the position data provided in the traffic alert provides a substantially accurate identification of the location of the traffic condition.

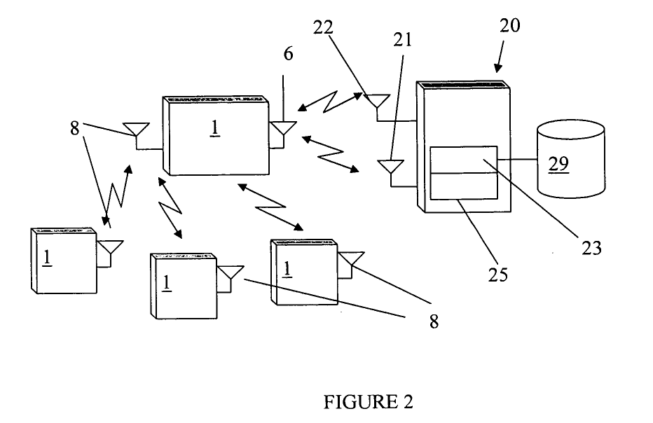

Referring to FIG. 2, the traffic alert can be sent to other mobile devices by the local area network transceiver 8 or to a network device 20 by a cellular transceiver 6. The network device may also have a transmitter 21 that sends a similar traffic alert or simply forwards the traffic alert to other mobile devices. It should be understood that the network transmitter 21 and receiver 22 may be included in a network transceiver.

It should be understood that a traffic jam condition, traffic congestion, or a traffic condition refers to stop-and-go traffic conditions and other traffic conditions that are consistent with travel speeds that are significantly slower than the posted maximum speed limit or traffic conditions that are unusual in comparison to the traffic conditions typically experienced along a particular road or area.

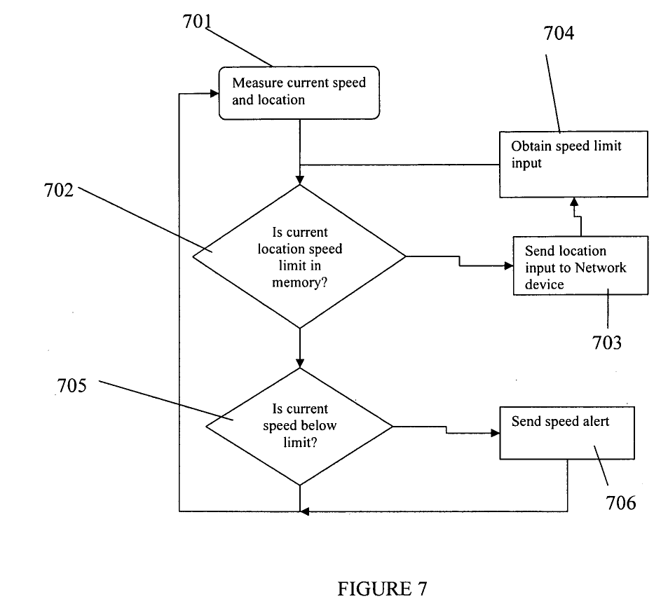

In another embodiment, the mobile device can determine if a vehicle is exceeding the posted speed limit of the road on which it is positioned. As shown in block 701 of FIG. 7, the processor of the mobile device monitors the speed input and location input received by the at least one receiver 7. If the memory 5 of the mobile device does not have the necessary speed limit input for the location of the mobile device, the cellular transceiver 6 sends the location input to the network device 20, as indicated in blocks 702-703.

The network device 20 has at least one receiver 22 configured to receive location input transmitted by the at least one transmitter 6 of the at least one mobile device, memory 25 having mapping data 29, at least one transmitter 21 configured to send encoded speed limit input to the at least one mobile device 1, and a processor 23. The mapping data 29 has speed limit input that includes the location of various roads and the maximum posted speed limits for those roads. The processor 23 of the network device is configured to compare location input received from the at least one mobile device with the speed limit input of the mapping data and encode the speed limit mapping data for the location input received from the at least one mobile device into encoded speed limit input so that the at least one transmitter 21 can send the encoded speed limit input to the at least one mobile device that corresponds to the location input received from that mobile device.

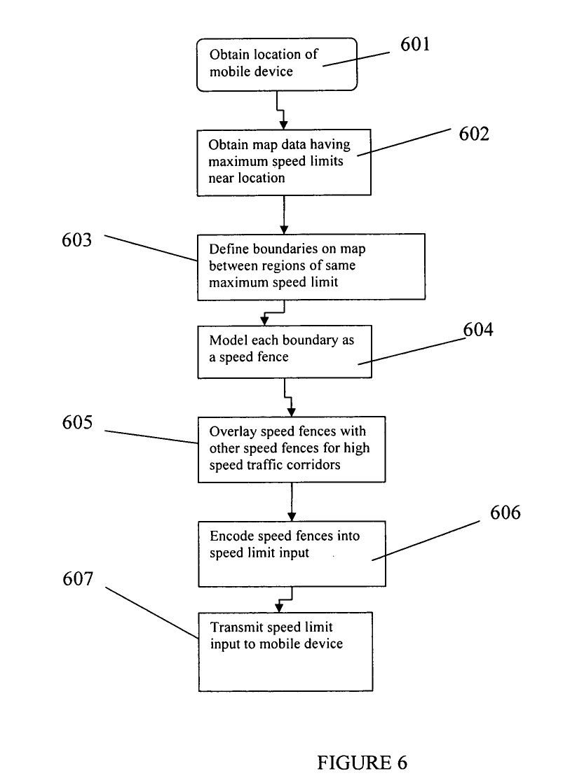

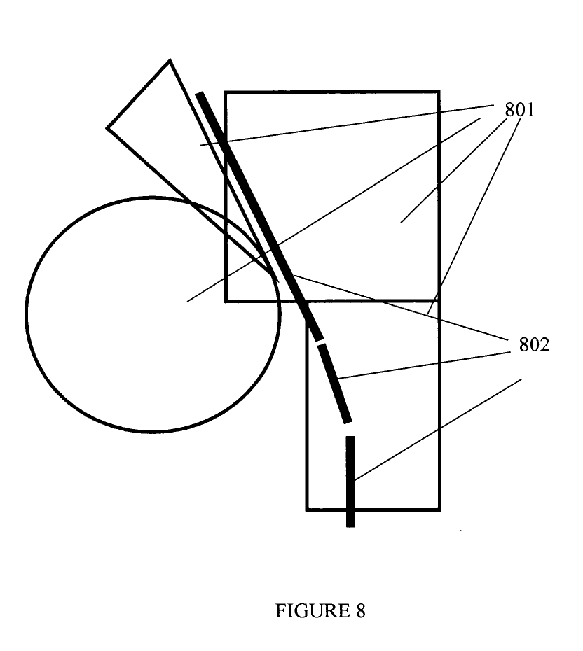

The steps the processor of the network device takes to encode the speed limit input is illustrated in FIG. 6. First the processor 23 obtains the location input from the receiver 21 of a mobile device, as illustrated by block 601. Then the processor 23 obtains map data that has the posted speed limits within a predetermined area near the location identified in the location input as illustrated in block 602. As may be understood by those skilled in the art, the predetermined area may be a small area, such as one mile, or a larger area such as fifteen miles. Of course, other predetermined areas may also be used. The boundaries of the predetermined area for regions having the same speed limit are then determined and encoded in different speed fences such that each speed fence 801 has a particular geographical boundary corresponding to the mapped data with a maximum speed limit value, as shown in FIG. 8 and indicated in blocks 603-604.

It should be understood that our use of the term “speed fence” refers to an encoded boundary that identifies a geometric shape within map data that defines the boundary of an area within the map data that has one maximum speed limit. The geometric shapes defined by the speed fences may be lines, polygons, circles, ovals, and/or other geometric shapes.

The processor 23 then encodes the coordinates of each speed fence into the speed limit input such that the speed limit input has at least one speed fence having a maximum speed limit value. As shown in FIG. 8 and block 605, lines 802 for high speed traffic corridors, such as interstates, may overlay the boundary speed fences. These overlayed lines 802 are also speed fences. The network device processor encodes the speed fences based on a prioritized protocol. For example, in one embodiment, the priority protocol can require the network processor to encode speed fences for the largest contiguous area with the same speed limit and subsequently encode speed fences for smaller areas such that the first speed fences encoded by the network device are overwritten by the latter ones to create an entire encoded speed limit input that provides data that may be extracted to obtain the mapping data 29 with the speed limit input.

The network processor 23 then encodes the various speed fences 801, 802 into a message format as shown in block 606. Preferably a short message system format is used for the speed limit input. It should be understood that other messaging formats known by those of skill in the art may be used, such as packet data messaging and other messaging formats. Then, the transmitter 21 sends the encoded speed limit input to the transceiver 6 of the mobile device, as indicated by blocks 607 of FIG. 6 and 704 of FIG. 7.

The processor of the mobile device then decodes the encoded speed limit input received by cellular transceiver 6 by unpacking the speed fences based upon the priority protocol used by the network device processor 23 to create a map having maximum speed limit zones that correlate to the maximum speed limits of the roads or routes near the mobile device. The processor 3 of the mobile device stores the speed limit input in the memory 5 after unpacking, or decoding, the speed fences. When the location of the mobile device is obtained from the location input, the processor compares the location input to the speed fences to determine if the current location of the mobile device is within one or more of the speed fences. If the location is within one or more of the fences, the highest priority fence is selected by the processor and the maximum speed limit value provided by the highest priority speed fence is compared to the current speed input to by the processor. If the speed input is greater than or equal to the maximum speed limit value, the processor generates a speed limit alert, as indicated in block 706. If the speed input is below the maximum speed limit value, the processor continues to monitor the speed input, as shown in block 705.

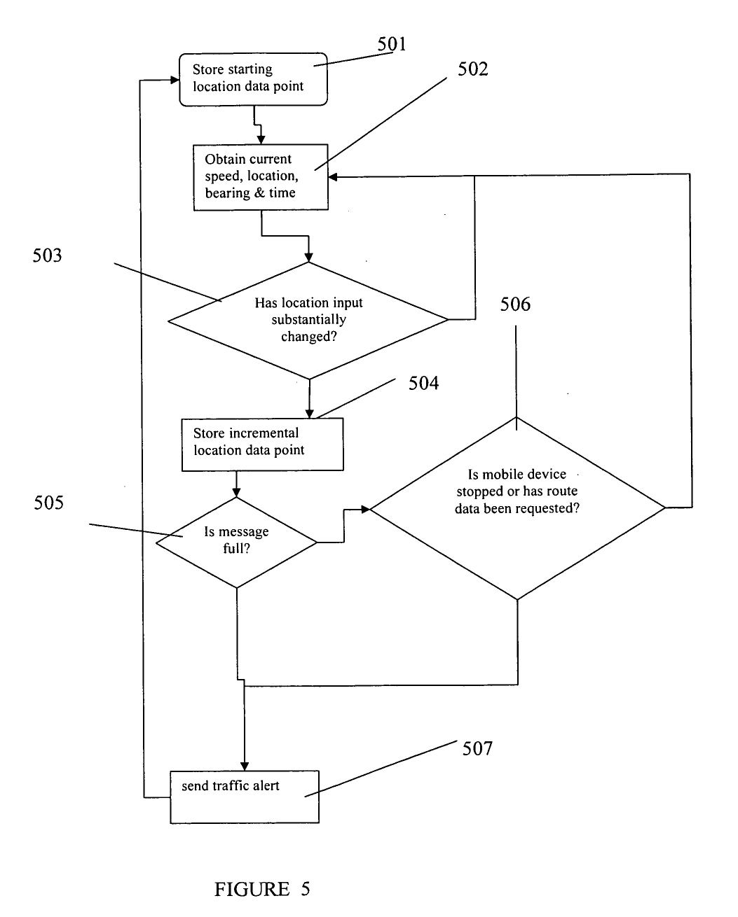

The mobile device may also store route data so the mobile device or a network device interfacing with the mobile device can record or track the travel history of the mobile device. Referring to FIG. 5, the processor of the mobile device can be configured to receive the location input and store the location input in the memory when the mobile device has substantially moved to a different location such that the memory of the mobile device may store the route the mobile device has traveled. The processor may take at least the following steps in storing such route data.

First, the processor may store route data, which has starting position data, which includes a first location input, and incremental position data, which includes at least one other location input. Similarly to the steps illustrated in FIG. 4, the processor may determine if the mobile device has begun substantially moving at a speed greater than zero miles per hour prior to recording a starting position data. In other embodiments, the processor may store starting position data in the memory 5 when the mobile device moves from a first location to a second location that is located substantially far away from the first location. Such a substantial distance can be as small as 10 feet or as long as 1 mile. Of course, other distances can also be included as a substantial change depending upon the desired accuracy and precision of the route data to be stored by the processor. Similarly, the processor can be configured to store incremental position data when a substantial change in any portion of the location input, such as a substantial change in speed, bearing, time or location is detected.

According to one embodiment, a change in location of about 0.6 minutes in at least one of longitude or latitude is sufficient to be considered a substantial change. Of course, as known to those skilled in the art, lesser changes in location can be considered to be a substantial change depending upon the desired amount of precision and accuracy of the route data. Similarly, a significant change in bearing, time and speed may also be considered a substantial change, the significance of the change being based upon a predetermined precision or accuracy requirement.

In one embodiment, a substantial change in time is considered to be at least ten minute, a substantial change in speed is considered to be at least a 25 mile per hour change in speed and a substantial change in bearing is considered to be at least a change of 22.5 degrees (e.g. from North to North North East). Of course, as previously mentioned, what constitutes a substantial change will depend upon the desired accuracy and precision the route data is desired to have. Thus, a lesser or greater change in speed, bearing, or location may be considered a substantial change. For example, in another embodiment, a substantial change may include at least about a 0.01 minute change in at least one of longitude or latitude for a substantial change in location, at least a one minute change in time, at least a 5 mile per hour change in speed or at least a 11.25 degree change in bearing.

Once the processor has stored a starting data point as part of the stored route data, the processor monitors at least one of the speed input and location input to determine when the at least one of speed input and location input of the mobile device has substantially changed. When at least one of the location input and speed input has substantially changed, the processor will store a second location input as an incremental data point, as indicated in blocks 502-505. The processor 3 will continue to periodically store additional location inputs as incremental data points whenever at least one of the location input and speed input substantially change, as indicated in block 504. Preferably, the processor will store the route data as a short message. When the memory is full, or when desired, the route data will be sent by the transmitter 6 to the network device 20. Alternatively, if the mobile device stops, the transmitter will transmit the store route data to the network device.

The memory 5 of the mobile device can then be erased, or overwritten by new route data. In an alternative embodiment, the route data can stay stored in the memory 5 and the processor can store additional route data in the memory 5.

It should be understood that the route data may be stored as a short message in the memory 5. Such a short message may have a header, a starting position, and at least one incremental position, wherein the starting position includes the starting point data and the at least one incremental position includes incremental route data. We prefer that the header include the ASCII data, $PATL, that the starting position includes location input, such as geographical positions in longitudinal and latitudinal coordinates, bearing, speed, and time input and the incremental route data include geographical position input, time input, bearing input and speed input. It should be understood that the input provided in the route data may all be obtained from only the location input received by the GPS receiver 11, or by a collection of input received by the at least one receiver 7. Similarly, it should be understood that time can include the date and time of a particular day or just the time as recorded by a counter or other time measuring device.

It should also be noted that the route data can also be referred to as a Logged Tracker Report or a Route Logging Report. Similarly, the storage of route data can be referred to as route logging.

The receiver 22 of the network device can be configured to receive the route data from the mobile device. The memory of the network device can be configured to have the processor 23 write the received route data to the memory 25 such that the route data of the mobile device is stored in the memory 25 of the network device. The memory can be configured to store the route data for each mobile device within a plurality of mobile devices that interface with the network device such that the processor can be configured to access the stored route data and display the paths taken by one or more of the mobile devices such that the paths are shown on computer screens or some other user interface 31 that may be operatively connected to the network device. For example, a computer operatively connected to the Internet may be able to access the network device 20 and download or remotely access the route data stored in the memory 25 of the network device for one or more mobile devices such that the computer can display the paths taken by the mobile devices or the last known or current location of each mobile device.

It should be understood that the route data stored by the memory 25 of the network device can retain historic route data such that the processor 23 can be configured to evaluate the historic route data and compare such data to recently received route data to determine whether a traffic condition exists, such as a traffic jam. If such a traffic condition is found to exist by the processor 23, the processor will generate a traffic alert that will be transmitted by transceiver 21 to other mobile devices.

For example, the processor 23 can be configured to compare the recently obtained route data from various mobile devices with historical route data previously obtained from other mobile devices near the same location as the mobile device. The network processor may evaluate the traffic condition by comparing the historical route data for the location of the mobile device with the recently obtained route data to determine if the speed of the mobile device is substantially less than the historical average of speed inputs for the location of the mobile device. If the mobile device is currently traveling substantially below the historical average of speed inputs, the network processor generates a traffic alert identifying a traffic condition at this location. Of course, the network processor may be configured to follow various other protocols to compare the historical route data with the recently obtained route data to determine whether a traffic condition exists

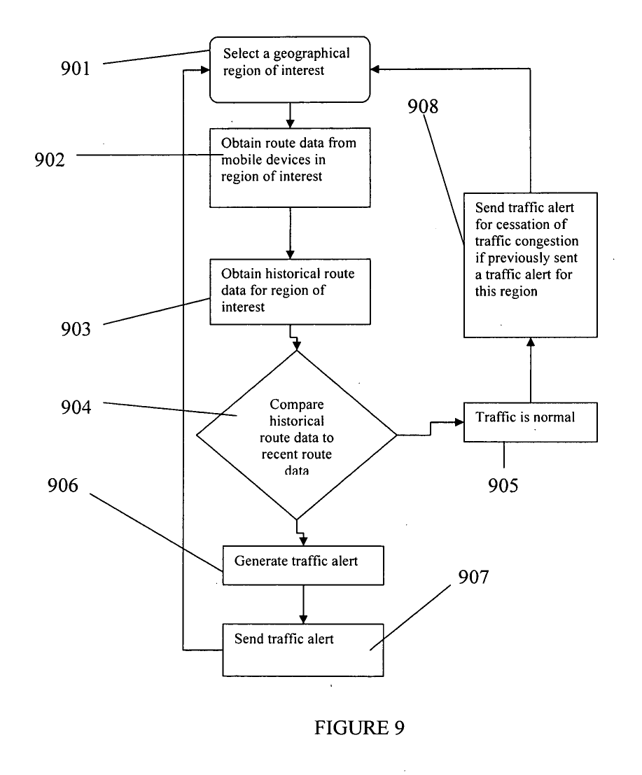

As another example, the network processor 23 can be configured to follow the protocol illustrated in FIG. 9. First the network processor may select a region or area of interest, then ensure the network receiver obtains route data from mobile devices within this region, as shown in blocks 901 and 902. Thereafter, the network processor recalls historical route data stored in the memory of the network device and compares the historical route data for the region with the recently obtained route data for the region, as shown in blocks 903 and 904. If there is no substantial difference between the historical and recent route data, the network processor determines that the traffic for this region is normal as shown in block 905. If the network processor determines that there is a substantial change, then it generates a traffic alert that the transmitter of the network device sends, as indicated in blocks 906 and 907. In the event the network processor previously issued a traffic alert due to a traffic slow down and subsequently determines that region has a normal traffic pattern, the processor 23 may generate a traffic alert identifying the cessation of the traffic condition for this area, as indicated in block 908.

All claims in this application, including but not limited to original claims, are hereby incorporated in their entirety into, and form a part of, the written description of the invention. Applicants reserve the right to physically incorporate into any part of this document, including any part of the written description, the claims referred to above including but not limited to any original claims. Patents, patent applications, publications, scientific articles, books, web sites, and other documents and/or materials referenced or mentioned herein are all incorporated by reference in their entirety, as if fully rewritten herein.

As used herein and in the appended claims, the singular forms “a,” “an,” and “the” include plural reference unless the context clearly dictates otherwise.

The terms and expressions employed herein have been used as terms of description and not of limitation, and there is no intention in the use of such terms and expressions, or any portions thereof, to exclude any equivalents now known or later developed, whether or not such equivalents are set forth or shown or described herein or whether or not such equivalents are viewed as predictable, but it is recognized that various modifications are within the scope of the invention claimed, whether or not those claims issued with or without alteration or amendment for any reason. Thus, it shall be understood that, although the present invention has been specifically disclosed by preferred embodiments and optional features, modifications and variations of the inventions embodied therein or herein disclosed can be resorted to by those skilled in the art, and such modifications and variations are considered to be within the scope of the inventions disclosed and claimed herein.

Specific methods and apparatuses described and depicted herein are exemplary and not intended as limitations on the scope of the invention. Other objects, aspects, and embodiments will occur to those skilled in the art upon consideration of this specification, and are encompassed within the spirit of the invention as defined by the scope of the claims. Where examples are given, the description shall be construed to include, but not to be limited to, only those examples. It will be readily apparent to one skilled in the art that varying substitutions and modifications may be made to the invention disclosed herein without departing from the scope and spirit of the invention, and from the description of the inventions, including those illustratively set forth herein, it is manifest that various modifications and equivalents can be used to implement the concepts of the present invention without departing from its scope. A person of ordinary skill in the art will recognize that changes can be made in form and detail without departing from the spirit and the scope of the invention. The described embodiments are to be considered in all respects as illustrative and not restrictive. Thus, for example, additional embodiments are within the scope of the invention and within the following claims.

We claim:

1. An apparatus for monitoring traffic conditions comprising at least one mobile device comprised of:
at least one receiver, the at least one receiver being configured to obtain at least one of speed input and location input, wherein the location input has at least one of a speed input or input the at least one receiver uses to generate a speed input;
memory, the memory being operatively connected to the at least one receiver, the memory being configured to store at least one of the speed input and the location input obtained by the at least one receiver;
a processor, the processor having a traffic speed level variable that defines a traffic speed level and a traffic jam time period variable that defines a traffic jam time period, the processor being operatively connected to the memory and the at least one receiver, the processor being configured to compare the speed input stored in the memory with the speed input that is obtained by the at least one receiver to determine when the speed input being obtained by the at least one receiver has been at or below a traffic speed level for at least a traffic jam time period, the processor being configured to generate a traffic alert when it determines the speed input being obtained by the at least one receiver has been at or below a traffic speed level for at least a traffic jam time period, the traffic alert being comprised of position data, the position data being comprised of the location input obtained by the at least one receiver at the time the traffic alert is generated; and
at least one transmitter, the at least one transmitter being operatively connected to the processor, the at least one transmitter being configured to send the traffic alert when the processor determines that the received speed input has been at or below a traffic speed level for at least a traffic jam time period.

2. The mobile device of claim 1 wherein the location input is comprised of at least one of time, bearing, speed and a geographical position of the mobile device.

3. The mobile device of claim 1 wherein the at least one receiver obtains the speed input by calculating the speed of the mobile device based upon the received location input.

4. The mobile device of claim 1 wherein the at least one receiver is also configured to receive traffic alerts.

5. The mobile device of claim 4 wherein the at least one transmitter is operatively connected to the at least one receiver and is also configured to transmit a traffic alert when the at least one receiver receives a traffic alert.

6. The apparatus of claim 1 further comprising a network device, the network device having at least one receiver configured to receive the traffic alert sent from the at least one mobile device.

7. The apparatus of claim 6 wherein the network device is further comprised of at least one transmitter that is operatively connected to the at least one receiver of the network device and wherein the at least one transmitter of the network device is configured to send traffic alerts to the at least one mobile device.

8. A mobile device comprising:
at least one receiver, the at least one receiver being configured to obtain location input, speed input and encoded speed limit input, the location input defining a location at which the mobile device is positioned, the encoded speed limit input being encoded such that it has at least one speed fence having a maximum speed limit value;
a processor, the processor being operatively connected to the at least one receiver, the processor being configured to decode the encoded speed limit input and compare the speed input with the speed limit input and generate a speed limit alert when it determines that the speed input is greater than or equal to the maximum speed limit value for the location; and
at least one transmitter, the at least one transmitter being operatively connected to the processor and the at least one receiver, the at least one transmitter being configured to transmit the location input obtained by the at least one receiver and send a speed limit alert when the processor determines that the speed input is greater than or equal to the maximum speed limit value.

9. The mobile device of claim 8 wherein the encoded speed limit input is a short message.

10. The mobile device of claim 8 wherein the speed limit alert is a short message.

11. The mobile device of claim 8 further comprising memory operatively connected to the at least one receiver, the memory being configured to store route data, the route data being comprised of at least one of the speed input and the location input.

12. The mobile device of claim 11 wherein the processor is configured to store the route data in the memory as an encoded short message.

13. The mobile device of claim 11 wherein the at least one transmitter is also configured to transmit the route data.

14. The mobile device of claim 8 wherein the location input is comprised of at least one of time, bearing, speed and a geographical position of the mobile device.

15. The mobile device of claim 8 wherein the speed limit alert is comprised of the location at which the mobile device is positioned when the processor generates the speed limit alert.

16. A mobile device comprising:
at least one receiver, the at least one receiver being configured to obtain speed input and location input;
memory; and
a processor, the processor being operatively connected to the at least one receiver and the memory, the processor being configured to store route data in the memory, the route data being comprised of starting point data and incremental point data, wherein the processor is configured to store a first location input as starting point data in the memory and thereafter evaluate the location input and speed input obtained by the at least one receiver and store a second location input as incremental route data in the memory when at least one of the speed input and location input substantially changes from the starting point data.

17. The mobile device of claim 16 wherein the processor stores the route data as a short message.

18. The mobile device of claim 17 wherein the short message is comprised of a header, a starting position, and at least one incremental position, wherein the starting position is comprised of the starting point data and the at lest one incremental position is comprised of the incremental route data.

19. The mobile device of claim 16 also comprising at least one transmitter, the at least one transmitter being operatively connected to the processor, the at least one transmitter being configured to send the route data.

20. The mobile device of claim 16 wherein the location input is comprised of at least one of a bearing, a time, a speed and a geographical position of the mobile device.

21. The mobile device of claim 16 wherein the location input substantially changes when the difference between the first location input and a second location input is at least one of at least a 0.6 minute change in at least one of latitude and longitude, at least a 10 minute change in time, at least a 25 mile per hour change in speed and at least a 22.5 degree change in bearing.

22. A system for monitoring the location of at least one object comprising:
at least one mobile device, that at least one mobile device being comprised of at least one receiver, the at least one receiver being configured to obtain location input, speed input and encoded speed limit input, the location input identifying a location at which the at least one mobile device is positioned, the encoded speed limit input being encoded such that it has at least one speed fence having a maximum speed limit value, a processor, the processor being operatively connected to the at least one receiver, the processor being configured to decode the. encoded speed limit input and compare the speed input with the speed limit input and generate a speed limit alert when it determines that the speed input is greater than or equal to the maximum speed limit value for the location, and at least one transmitter, the at least one transmitter being operatively connected to the processor and the at least one receiver, the at least one transmitter being configured to transmit the location input received by the at least one receiver and send a speed limit alert when the processor determines that the speed input is greater than or equal to the maximum speed limit value for the location; and
a network device, the network device having at least one receiver configured to receive location input transmitted by the at least one transmitter of the at least one mobile device, memory having speed limit mapping data, at least one transmitter configured to send encoded speed limit input to the at least one mobile device, and a processor configured to compare location input received from the at least one mobile device with the speed limit mapping data and encode the speed limit mapping data for the location input received from the at least one mobile device into encoded speed limit input so that the at least one transmitter can send the encoded speed limit input to the at least one mobile device that corresponds to the location input received from that mobile device, wherein the speed limit input is encoded such that is has at least one speed fence having a maximum speed limit value.

23. The system of claim 22 wherein the location input is comprised of at least one of speed, bearing, time, and geographical position of the mobile device.

24. The system of claim 22 wherein the encoded speed limit input is a short message.

25. The system of claim 22 wherein the at least one mobile device is further comprised of memory operatively connected to the processor of the mobile device, wherein the processor of the mobile device is configured to store route data in the memory of the mobile device, the route data being comprised of at least one of location input and speed input.

26. The system of claim 25 wherein the route data is stored as a short message.

27. The system of claim 25 wherein the at least one transmitter of the at least one mobile device is also configured to send route data and wherein the at least one receiver of the network device is also configured to receive the route data sent by the at least one transmitter of the at least one mobile device.

28. The system of claim 27 wherein the memory of the network device is also configured to store the route data received by the at least one receiver of the network device.

29. The system of claim 28 wherein the processor of the network device is also configured to access the route data stored by the memory of the network device to find the route data for at least one of the at least one mobile device.

30. The system of claim 29 wherein the processor of the network device is also configured to access the route data stored by the memory of the network device and determine when a traffic condition exists based on the route data and generate a traffic alert and wherein the at least one transmitter of the network device is also configured to send the traffic alert of the processor of the network device to the at least one mobile device.

31. The system of claim 22 wherein the speed limit alert is a short message.

32. A system of recording the movement of at least one object comprising:
at least one mobile device comprised of at least one receiver, the at least one receiver being configured to obtain speed input and location input, memory, a processor, the processor being operatively connected to the at least one receiver and the memory, the processor being configured to store route data in the memory, the route data being comprised of starting point data and incremental point data, wherein the processor is configured to store a first location input as starting point data and thereafter monitor the location input and speed input received by the at least one receiver and store location input being received by the at least one receiver as incremental route data in the memory when one of the speed input and location input substantially changes, and at least one transmitter, the at least one transmitter being operatively connected to the processor and being configured to send the route data; and
a network device, the network device having at least one receiver configured to receive the route data sent by the at least one transmitter and having memory configured to store the route data received by the at least one receiver of the network device for each mobile device.

33. The system of claim 32 wherein the processor is configured to store the route data in the memory of the mobile device as an encoded short message.

34. The system of claim 32 wherein the network device is further comprised of a processor, the processor being operatively connected to the memory of the network device and the at least one receiver of the network device, the processor of the network device being configured to decode the route data sent by the transmitter of the at least one mobile device and store the decoded route data in the memory of the network device for each mobile device.

35. The system of claim 34 wherein the processor is also configured to display the route data of at least one of the at least one mobile devices that is stored in the memory of the network device.

36. The system of claim 32 wherein at least one of the at least one transmitter and one of the at least one receiver of the at least one mobile device is at least one transceiver.

37. The system of claim 32 wherein the network device is further comprised of a processor operatively connected to the memory of the network device, the processor of the network device being configured to access the route data and compare the route data received by the at least one receiver of the network device with route data previously received by the at least one receiver of the network device and stored in the memory of the network device to determine if a traffic condition exists and generate a traffic alert when the processor of the network device determines that a traffic condition exists.

38. The system of claim 37 wherein the network device is also comprised of a transmitter configured to send the traffic alert.

39. A method of monitoring traffic conditions comprising:
installing at least one mobile device in a plurality of vehicles, wherein the at least one mobile device is comprised of at least one receiver, the at lest one receiver being configured to obtain at least one of speed input and location input and at least one transmitter configured to send at least one of speed input and location input obtained by the at least one receiver;
determining that the vehicle is moving;
storing a starting data point;
storing an incremental data point whenever at least one of the location input and speed input received by the at least one receiver of the mobile device substantially changes;
sending route data as a short message, wherein the route data is comprised of the starting data point and the incremental data points.

40. The method of claim 39 further comprising compressing the route data.

41. The method of claim 39 further comprising encoding the route data as a short message.

42. The method of claim 39 further comprising storing route data received form the at least one mobile device, evaluating route data received from the at least one mobile device to determine areas having traffic congestion, and sending alerts identifying the areas having traffic congestion erasing the route data.

43. The method of claim 39 further comprising erasing the route data from the mobile device.

44. The method of claim 39 further comprising displaying the route data of at least one of the at least one mobile devices.

45. A method of sending speed limit alerts comprising:
installing at least one mobile device in at least one vehicle, wherein the at least one mobile device is comprised of at least one receiver, the at lest one receiver being configured to obtain speed limit input and at least one of speed input and location input and at least one transmitter configured to send at least one of speed input and location input received by the at least one receiver;
receiving speed input for the vehicle;
receiving location input from the at least one receiver of the at least one mobile device;
encoding speed limit input for the location input received from the at least one receiver of the at least one mobile device into at least one speed fence having a maximum speed limit value;
sending the encoded speed limit input to the at least one receiver of the at least one mobile device;
decoding the speed limit input received by the at least one receiver of the at least one mobile device;
determining whether the speed input is greater than or equal to the maximum speed limit value; and
sending a speed limit alert when the speed input is greater than or equal to the maximum speed limit value.

46. The method of claim 45 also comprising storing at least one of the location input and speed input as route data.

47. The method of claim 46 further comprising sending the route data.

48. The method of claim 44 wherein the route data is stored as a short message.

49. A method of evaluating traffic conditions comprising:
installing at least one mobile device in at least one vehicle, the at least one mobile device having at least one receiver configured to obtain speed inputs and location inputs and at least one transmitter configured to send traffic alerts and at least one of speed inputs and location inputs;
determining if the vehicle is moving;
recording at least one of speed input and location input as route data;
evaluating the speed of the vehicle to determine if a traffic condition exists;
sending a traffic alert when a traffic condition exists.

50. The method of claim 49 further comprising receiving the traffic alert and conveying the traffic alert to other mobile devices.

51. The method of claim 49 further comprising sending the route data.

52. The method of claim 51 further comprising erasing the route data.

53. The method of claim 52 further comprising receiving route data from at least one of the at least one mobile device and storing the route data received from each mobile device.

54. The method of claim 53 further comprising comparing route data received from the mobile device with historical traffic data to determine whether a traffic condition exists.

55. The method of claim 54 further comprising sending a traffic alert when a traffic condition exists.

56. A method of encoding speed fences comprising:
receiving location input from a mobile device;
obtaining map data, the map data having speed limit data;
defining boundaries of the map data that correspond with the speed limit data;
modeling each of the boundaries of the map data as speed fences;
encoding the speed fences into a short message; and
transmitting the short message to the mobile device, wherein the short message is comprised of the speed limit input.

57. The method of claim 56 further comprising overlaying the speed fences with speed fences for high speed traffic corridors.

58. The method of claim 56 further comprising prioritizing the speed fences.
